(19) United States
(12) Patent Application Publication
(10) Pub. No.: US 2012/0054087 A1
(43) Pub. Date: Mar. 1, 2012

(54) Method of providing financial services to a consumer

(75) Inventors: Cheryl King Kaczmarek, Appleton, WI (US); Carla L. Altepeter, Oshkosh, WI (US); William J. Wuske, JR., Ripon, WI (US); Todd J. Ziglinski, Oshkosh, WI (US); Steve Tyink, Appleton, WI (US); Ken W. Buksnes, Neenah, WI (US); Dale P. O'Keefe, Appleton, WI (US)

(73) Assignee: Citizens First Credit Union

(21) Appl. No.: 12/807,197

(22) Filed: Aug. 31, 2010

(51) Int. Cl. G06Q 40/00; G06Q 90/00

(52) U.S. Cl. 705/38; 705/500

(57) ABSTRACT

A method for providing financial services to a consumer seeking a loan that is designed to ease the difficult and stressful process and make it more comfortable and understandable for the consumer. The method comprises providing an office environment that is representative of a home, which may include a kitchen area, living room area, and dining room area—intended to make the consumer feel “at home” during the financial process. The method further includes a specific regimen to be followed by the financial advisor focused on generating a feeling of loyalty and friendliness to provide comfort for the consumer. Finally, the method provides a research center which provides additional resources for the consumer to help them more thoroughly understand the process.

### BACKGROUND OF THE INVENTION

Financial transactions, especially complex financial transactions can cause a significant amount of stress to at least one party involved, especially when the one party is a typical consumer who has very little knowledge or expertise pertaining to the transaction. For example, a majority of individuals will, at some point in their lives, go through the mortgage process when buying, building, maintaining, or improving a home. The process of getting a mortgage involves reviewing the credit report, determining the types and amounts of loans the individual qualifies for, exploring budgets and payment plans, applying, obtaining pre-approval, and completing a mass of paperwork, all prior to receiving a mortgage and moving towards the ultimate home goal. Often this process is long, discouraging, uncomfortable, and stressful. The present methods utilized by credit unions, banks, mortgage providers and other financial institutions leave consumers feeling uninformed and ignorant due to their unfamiliarity with the process, terminology, and their options. Consumers who participated in a focus group study describe a strong desire for a “counselor” or “consultant” that they can trust to help them and look out for them during all stages of the financial transaction, rather than a salesperson.

### SUMMARY OF THE INVENTION

Accordingly, the present approach provides this “counselor”, as well as a more comfortable and understandable methodology and environment for the financial transaction such as a mortgage process. This approach removes the stress, mystery, and imbalance of power through several unique principles and features including, first, a re-creation of the home environment within the office space, known as the “Home Suite” environment, where consumers will meet with their financial advisor. The approach welcomes the whole family into the Home Suite environment and allows the family to “make themselves at home”, providing comfortable space for all members, even including toys and entertainment for young children. The present invention further includes a welcoming and trust-worthy loan advisor to guide the consumer through the seemingly complex process, who follows a specific regimen that personalizes the process and makes it more comfortable for the consumer in many ways, including a tangible, highly visual explanation of credit reports, loan options, loan applications, and other details, and providing to the consumer support and clarity to help them understand the financial transaction process. Finally, the present invention includes various unique products created to support consumers with the financial side of all of the phases of the intended financial transaction and resources to educate the consumer in all aspects of the process. This business methodology demystifies and soothes the stress of the process by providing comfort, education, personalization, loyalty, and expert advice.

### BRIEF DESCRIPTION OF THE DRAWINGS

FIG. 1 illustrates an example of the office suite provided by the present method that replicates the common aspects and atmosphere of a home.

FIG. 2 illustrates a different view of the home suite depicted in FIG. 1.

FIG. 3 illustrates one embodiment of the front door of the office suite provided by this method.

FIG. 4 is a summary flowchart illustrating the method of the present invention.

FIGS. 4A-4D are an exemplary flowchart illustrating the method of the present invention.

### DESCRIPTION OF THE PREFERRED EMBODIMENT

Although the disclosure hereof is detailed and exact to enable those skilled in the art to practice the invention, the disclosure herein merely exemplifies the invention which may be embodied in other ways. While the preferred embodiment has been described, the details may be changed without departing from the invention, which is defined by the claims.

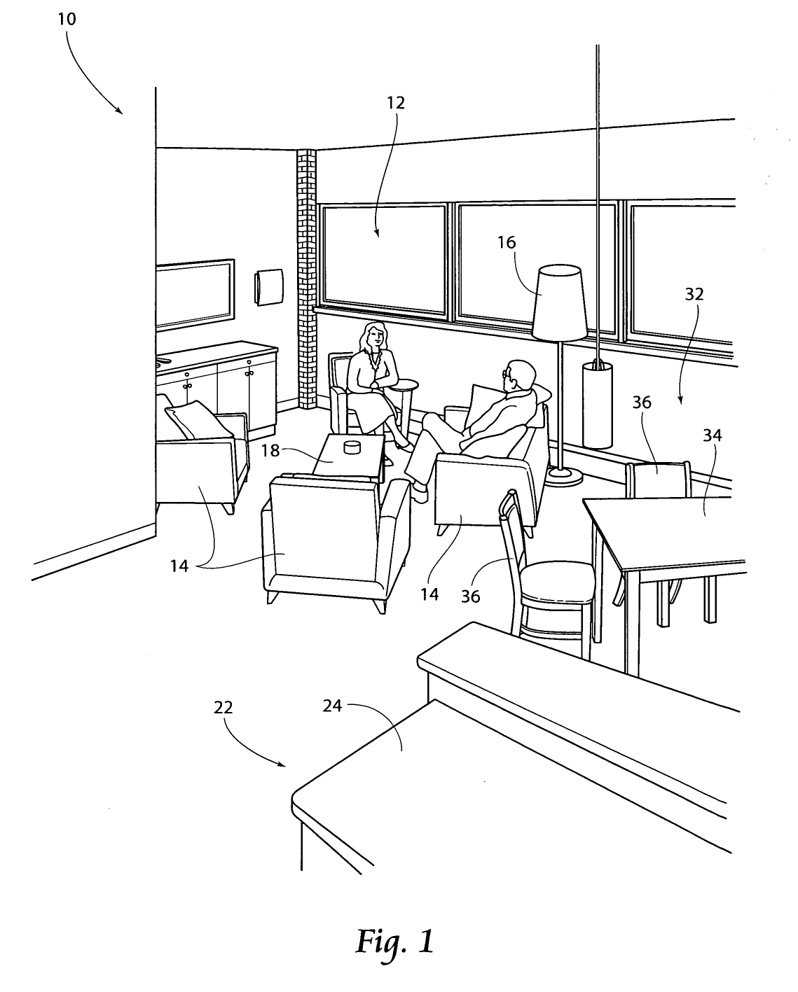

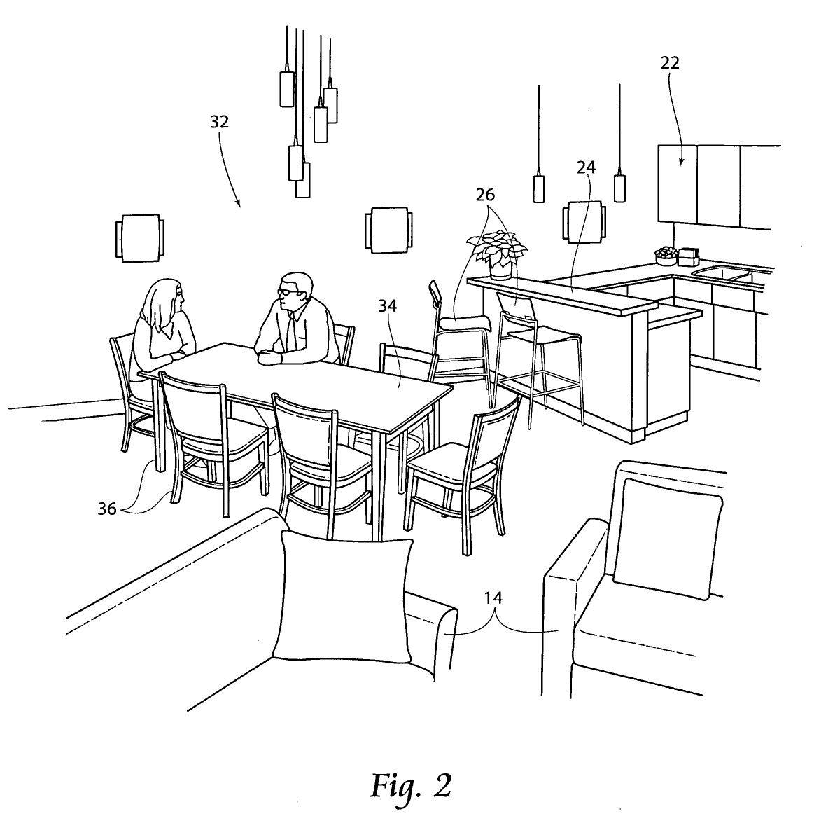

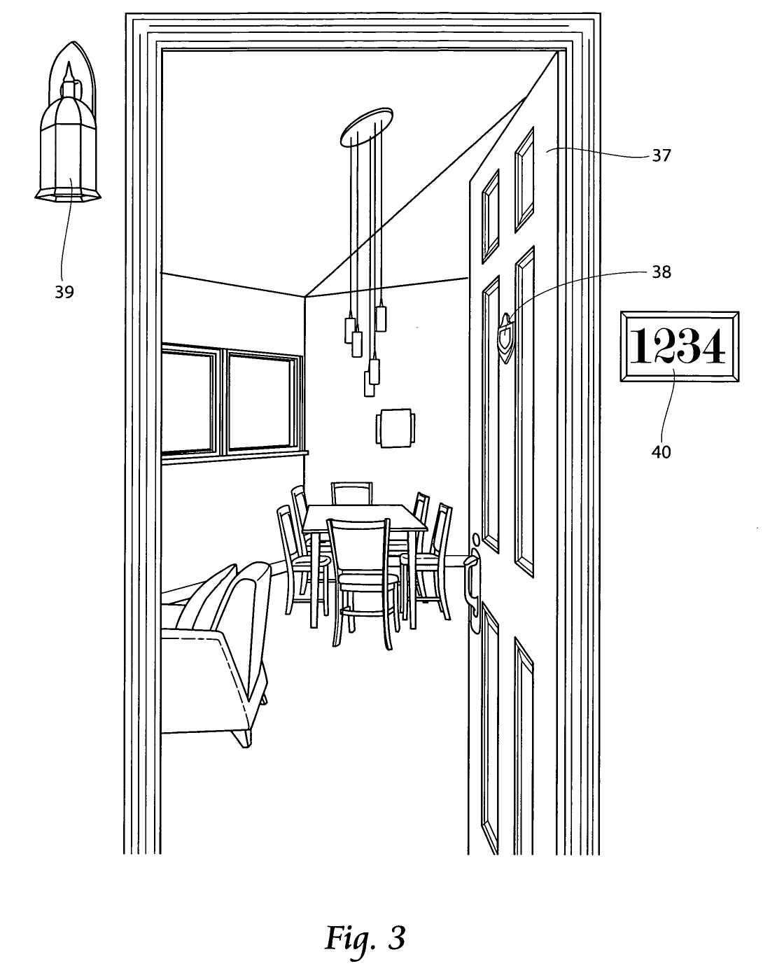

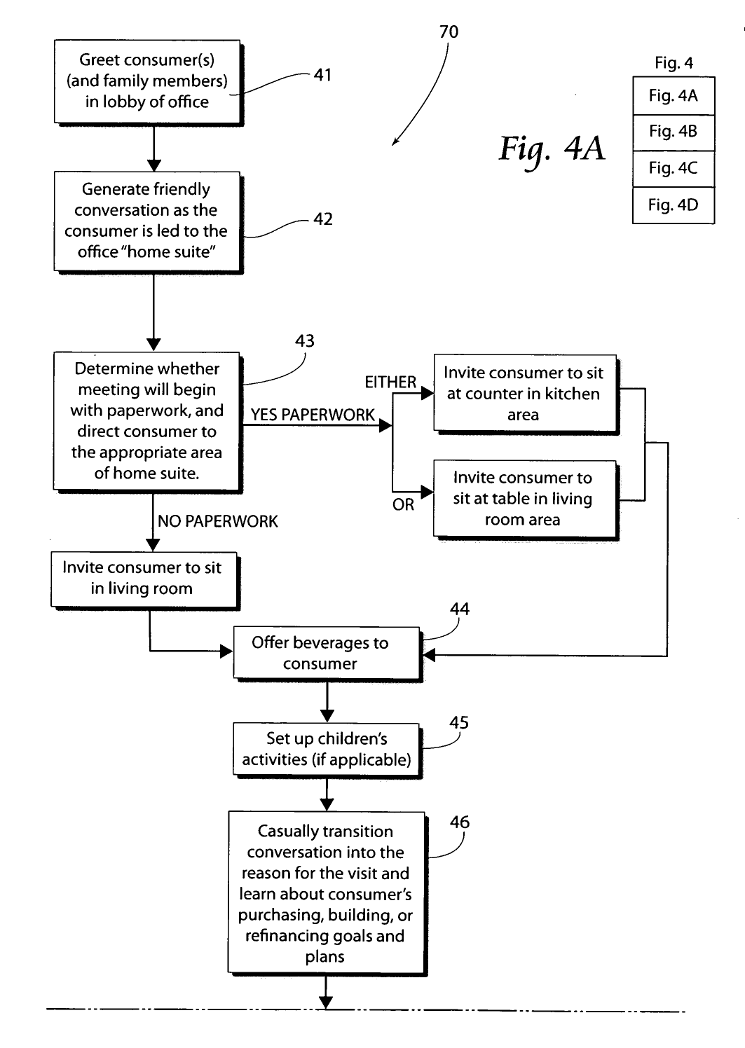

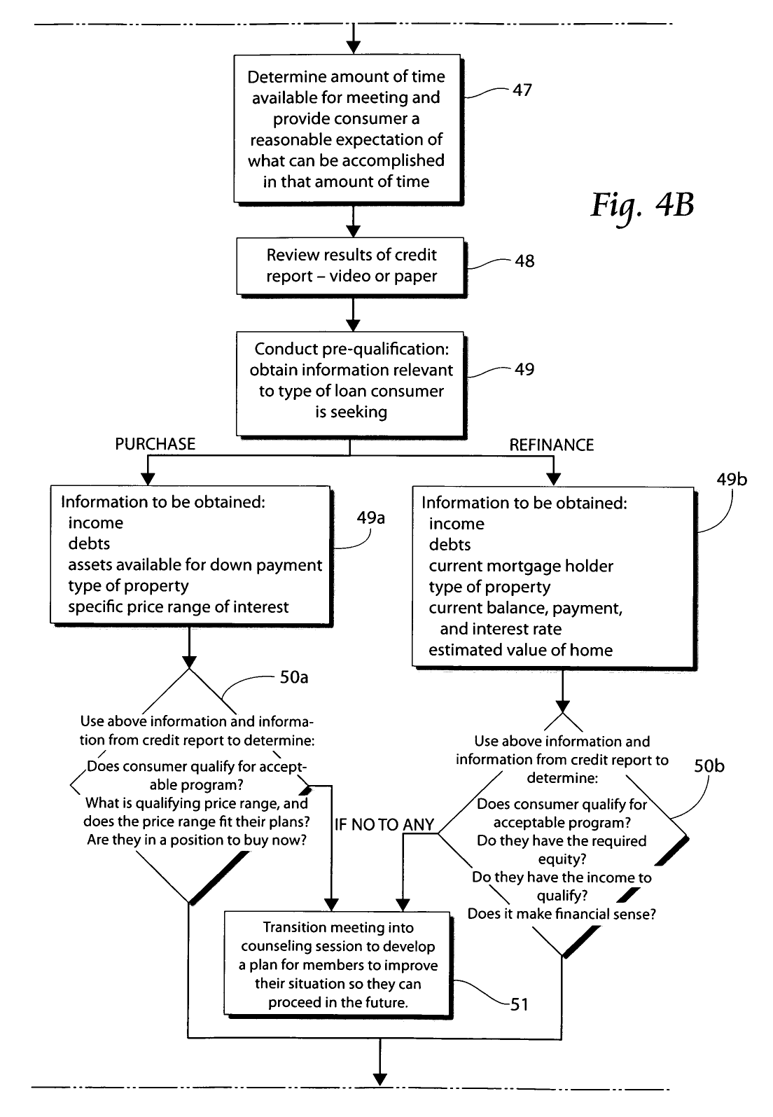

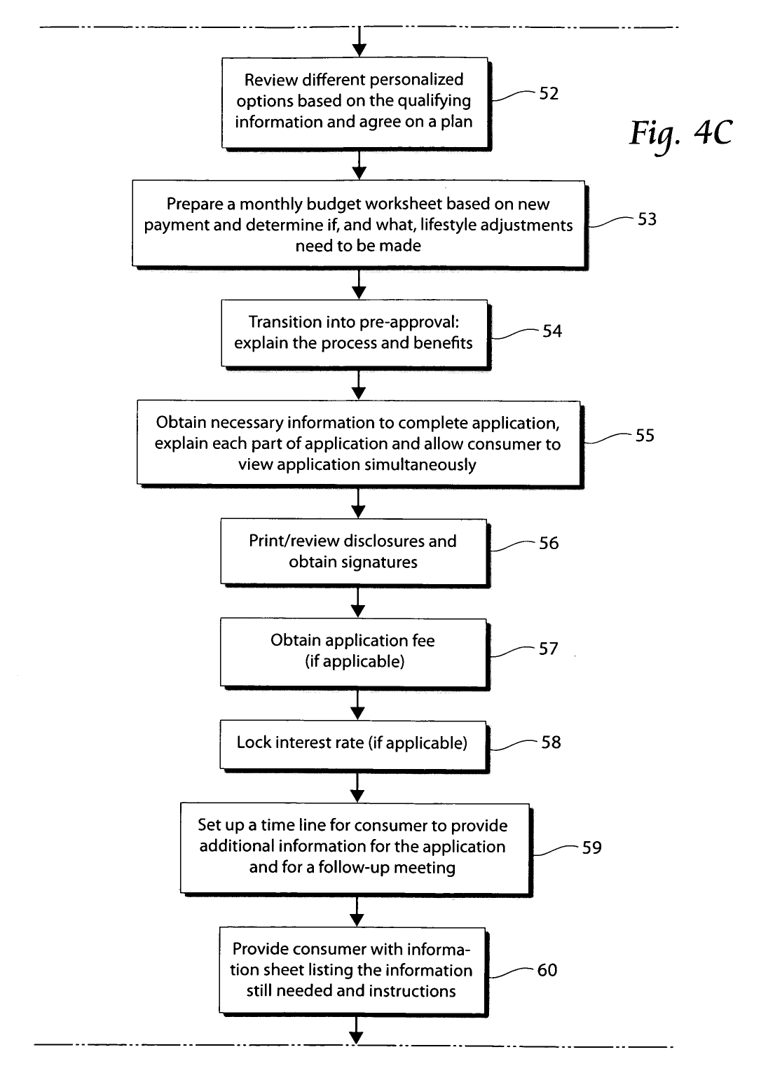

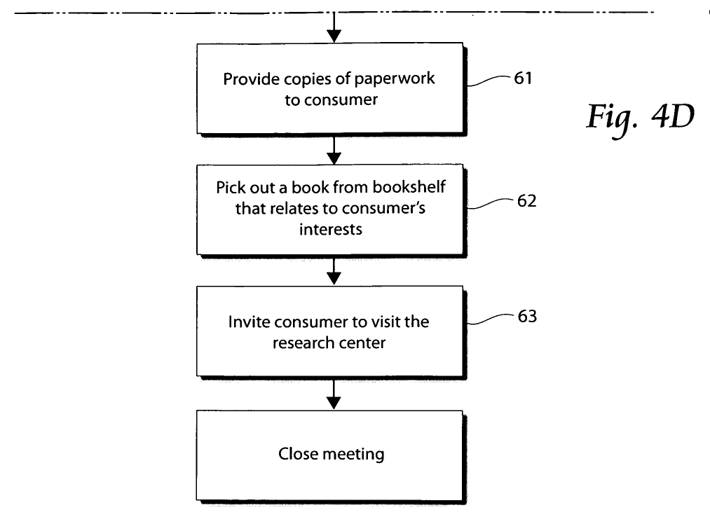

The present invention is a method to guide a consumer through a complex financial transaction such as the home financing process. The method provides a consumer with a loan advisor, or “home loan architect” who welcomes the consumer to the meeting with friendly conversation and guides the consumer into a unique office setting, shown by steps 41 and 42 in FIG. 3. The office is designed to re-create the comfort and familiarity of a home environment, as shown specifically in FIG. 1. The entrance to the office, or “home suite,” may be an ordinary office door, but may alternatively represent the front door of a home to complete the “at home” feel, as shown in FIG. 3, which may include details such as a porch light, door knocker, and address plaque. The interior is representative of a home, which may include a living room 12, kitchen 22, dining room area 32, and children's play area. The living room 12 includes comfortable furniture 14 and various home accessories 16 that evoke a pleasant, cozy feeling, and is the setting for informal discussions and exchanging of information. The kitchen 22 may have a breakfast bar with a counter 24 and stools 26, or a similar area that provides a less formal environment for discussions involving some paperwork or other materials. The dining room area 32 has a table 34 wherein more formal discussions, document review, computer work, and paperwork may take place. This environment removes the feelings of an imbalance in power by removing the barrier of a desk, and replacing it with an open, soft setting. To further the at-home atmosphere, all members of a family are invited to attend the meeting; even children are welcomed and may be provided with an area to play.

In addition to the Home Suite environment, the present invention may include a specific regimen 70, or script, to be followed when a consumer comes in for a meeting, designed to maintain a comfortable, conversational, and understandable approach throughout the financial transaction process. The elements of the regimen 70 are shown in FIG. 3. The figure and the following description detail the complete process 70, but not all steps are required at a single setting, or at all, depending on time constraints, and/or the needs and present financial capabilities of the consumer. Under the regimen of the present invention, the home loan architect will welcome the consumer into a particular area of the Home Suite environment, generally determined by the purpose of the discussion and what tasks will take place during the meeting (step 43). If paperwork or computer use is involved, the kitchen breakfast bar or dining room table may be used. If the meeting will begin with general conversation, the consumer may be led to the living room. As the meeting progresses, the conversation may be moved to a more appropriate area of the Home Suite environment, depending on the necessities of the discussion. The consumer(s) and family members may be offered a beverage to further the “at home” feel (step 44), and children's activities may be set up if young children have accompanied their parent(s) to the meeting (step 45). The home loan architect will casually transition the discussion into the reason for the visit, and learn more about the goals and plans of the consumer (step 46). After understanding the long-term goals of the consumer, the loan advisor should determine the amount of time available for the meeting, and ascertain that the consumer has a reasonable expectation of what can and will be accomplished during that time (step 47). The substance of the meeting may include a detailed explanation and review of the consumer's credit report (step 48), which may be done on paper or a video display, so that consumer is able to clearly see all the information on the report. This is followed with a conversational approach to obtain relevant information for pre-qualification (step 49), such information being dependant on whether the needs are for purchase (see step 49a) or refinancing (see step 49b). With this information, the advisor will determine whether the consumer qualifies for a loan (step 50) or needs to make a plan to improve their situation to proceed in the future (step 51).

If qualified, the home loan architect will thoroughly review different options that are available to the borrower (step 52). After thorough discussion and explanations, the borrower and advisor will agree on a personalized plan. In accordance with the chosen plan, a monthly budget is prepared so that the consumer can see the impact of the plan on their monthly budget and determine if, and what, lifestyle changes need to be made to accommodate the payment (step 53). Once this is confirmed, the regimen directs the loan advisor to transition into pre-approval, by specifically explaining what pre-approval is, and the benefits thereof (step 54). At this time the advisor may move the parties to the dining room area 32 of the home suite, if not already there, to accommodate use of a computer screen that may be shared between the advisor and the consumer, and documents reviewed simultaneously. The consumer then provides the necessary information to complete the application and, preferably using a television or computer screen showing the application, the consumer is able to look on as the information is entered directly into the system (step 55). All relevant disclosures and documents are printed and reviewed, and necessary signatures obtained (step 56). This step may also include paying the application fee (step 57) and locking an interest rate, if applicable (Step. 58). Then, the consumer and the home loan advisor may set up a time line for the consumer to provide any additional information that may be needed for the application and for a follow-up meeting (step 59) and provide consumer with an information sheet that lists the information they still need to provide and instructions to do so (step 60).

When finished, the consumer may receive copies of the paperwork, either physical copies or a form of digital media (step 61). As a personal detail, before leaving the Home Suite environment, the loan advisor may go to a bookshelf and pick out a book that relates to an interest that member mentioned during casual conversation (step 62). Finally, the consumer may be invited to visit an on-site research center that provides resources, information, and other relevant tools the consumer may be interested in utilizing (step 63).

The present invention provides a multitude of benefits over the presently used financial transaction application methods, specifically: providing the consumer with all the information to make informed and confident decisions, and giving consumers the opportunity and the comfortable atmosphere to thoroughly understand the information being presented; personalizing options to specifically fit the needs and goals of the consumer as determined by the casual and engaging conversations that take place between the consumer and the home loan advisor; and demonstrating an increased level of loyalty to the consumer by utilizing these unique features.

The foregoing is considered as illustrative only of the principles of the invention. Furthermore, since numerous modifications and changes will readily occur to those skilled in the art, it is not desired to limit the invention to the exact methods and operation shown and described. While the preferred embodiment has been described, the details may be changed without departing from the invention, which is defined by the claims.

I/We claim:

1. A method of providing financial services to a consumer seeking a loan, said method comprising the steps of:
providing a financial advisor;
providing a meeting space designed and configured to be representative of a home, having at least one area that functions as it would in a home;
providing a specific plan focused on ease, comfort, and understandability for said consumer to be followed during said providing of financial services;
implementing said plan during a meeting with said consumer, wherein said plan further comprises the steps of:
a) introducing said consumer to said financial advisor;
b) said financial advisor leading said consumer into one of said at least one area of said meeting space that is appropriate for said meeting, determined by the purpose and tasks of said meeting;
c) discussing a purpose of visit with said consumer;
d) determining whether said consumer qualifies for a loan; and
e) completing a loan application.

2. The method of claim 1 wherein said office space comprises a living room area, dining area, and kitchen area.

3. The method of claim 1 wherein said office space comprises an entrance representative of a front door of a home

4. The method of claim 3 wherein said entrance comprises a door and at least on selected from the group of door knocker, porch light, and number plate

5. The method of claim 1 further including the step of providing activities for children and a play area in said meeting space.

6. The method of claim 1 wherein the services are provided within a financial institution.

7. The method of claim 1 wherein the services are provided within a bank.

8. The method of claim 1 wherein the services are provided within a credit union.

9. The method of claim 1 further comprising the step of providing a research center wherein said consumer may access additional resources related to said financial services.

10. A method of providing financial services to a consumer seeking a home loan or mortgage, said method comprising the steps of:
providing a financial advisor;
providing a meeting space designed and configured to be representative of a home, having at least one area that functions as it would in a home;
providing a specific plan focused on ease, comfort, and understandability for said consumer to be followed during said providing of financial services;
implementing said plan during a meeting with said consumer, wherein said plan further comprises the steps of:
a) introducing said consumer to said financial advisor;
b) said financial advisor leading said consumer into one of said at least one area of said meeting space that is appropriate for said meeting, determined by the purpose and tasks of said meeting;
c) discussing a purpose of visit with said consumer;
d) reviewing the consumer's credit report;
e) obtaining information from said consumer;
f) determining whether said consumer qualifies for a loan;
g) discussing options with said consumer; and
h) completing a loan application.

11. The method of claim 10 wherein said office space comprises a living room area, dining area, and kitchen area.

12. The method of claim 10 wherein said office space comprises an entrance representative of a front door of a home

13. The method of claim 12 wherein said entrance comprises a door and at least one selected from the group of door knocker, porch light, and number plate

14. The method of claim 10 further including the step of providing activities for children and a play area in said meeting space.

15. The method of claim 10 wherein the step of reviewing results of consumer's credit report is done on a video screen.

16. The method of claim 10 wherein the step of reviewing results of consumer's credit report is done on a computer monitor.

17. The method of claim 10 further comprising the step of providing a research center wherein said consumer may access additional resources related to said financial services.

18. The method of claim 10 wherein the services are provided within a financial institution.

19. The method of claim 10 wherein the services are provided within a bank.

20. The method of claim 10 wherein the services are provided within a credit union.
